(19) United States
(12) Patent Application Publication
(10) Pub. No.: US 2014/0026079 A1
(43) Pub. Date: Jan. 23, 2014

(54) SYSTEM AND METHOD FOR CHATTING IN A VIRTUAL FORUM

(71) Applicants: Christopher Lee Graham, Houston, TX (US); Jeff Weston Jenkins, Cypress, TX (US)

(72) Inventors: Christopher Lee Graham, Houston, TX (US); Jeff Weston Jenkins, Cypress, TX (US)

(73) Assignee: Christopher Lee Graham, Houston, TX (US)

(21) Appl. No.: 13/555,330

(22) Filed: Jul. 23, 2012

(51) Int. Cl. G06F 3/01

(52) U.S. Cl. 715/758

(57) ABSTRACT

A system and method for debating in a virtual forum, such as an on-line chat room. A user may select one competitor to support. The competitor selected may be one of the competitors in a specific competitive event, such as a game, or one of the competitors in an association of competitors, such as a sports league. A plurality of virtual chat rooms may be created for debate over a competitive event. The populations of users in each of the plurality of virtual chat rooms may be based on the selection of competitors by the users.

### BACKGROUND

1. Field Of The Invention

The present invention relates generally to a system and method for chatting in a virtual forum and, more specifically, to a system and method for debating in an on-line chat-room.

2. Description Of The Related Art

This section is intended to introduce the reader to aspects of art that may be related to aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Sports play a significant cultural, as well as commercial, role in society. The passion of sports fans to discuss, as well as watch, sporting events, teams, and players, has given rise to numerous venues for such discussion. For example, it is not uncommon for a city to have one or more radio stations with a sports-talk format. In addition, the Internet has numerous sports blogs, fan pages, message boards, and chat rooms that enable fans to discuss and argue over their favorite sports, players, teams, or events.

Politics and entertainment raise similar passions. Numerous political talk-format radio stations may be found in most large cities. In addition, sports and entertainment websites, blogs, and chat rooms are also common.

However, each of these forums has their own problems that keep fans from maximizing their enjoyment. The present invention is designed to overcome the deficiencies of these other forums.

### SUMMARY OF THE INVENTION

A system and method for debating in a virtual forum, such as an on-line chat room. A user may select one competitor to support. The competitor selected may be one of the competitors in a specific competitive event, such as a game, or one of the competitors in an association of competitors, such as a sports league. A plurality of virtual chat rooms may be created for debate over a competitive event. The populations of users in each of the plurality of virtual chat rooms may be based on the selection of competitors by the users.

### BRIEF DESCRIPTION OF THE DRAWINGS

Advantages of the invention may become apparent upon reading the following detailed description and upon reference to the drawings in which:

FIG. 1 is an image of a Smartphone display having an icon linked to an application stored in the Smartphone, in accordance with embodiments of the present techniques;

FIG. 2 is an image of a Smartphone display illustrating the main menu of the application of FIG. 1, in accordance with embodiments of the present techniques;

FIG. 3 is an image of a Smartphone display illustrating a first user set-up page of the application of FIG. 1, in accordance with embodiments of the present techniques;

FIG. 4 is an image of a Smartphone display illustrating a second user set-up page of the application of FIG. 1, in which a user is provided with a selection of sports and/or events in which to indicate an allegiance or fandom, in accordance with embodiments of the present techniques;

FIG. 5 is an image of a Smartphone display illustrating a third user set-up page of the application of FIG. 1, in which a user indicates a primary allegiance or fandom or a specific team or person based on the selection made in the previous page, in accordance with embodiments of the present techniques;

FIG. 6 is an image of a Smartphone display illustrating a summary page of the application of FIG. 1, in which the user's indicated team or person primary allegiances or fandom is presented, in accordance with embodiments of the present techniques;

FIG. 7 is an image of a Smartphone display illustrating the main menu of the application of FIG. 1, in which a user has selected to review a schedule of games in which to chat using the application of FIG. 1, in accordance with embodiments of the present techniques;

FIG. 8 is an image of a Smartphone display illustrating a user selecting a specific game from the schedule of games of FIG. 7, in which to chat using the application of FIG. 1, in accordance with embodiments of the present techniques;

FIG. 9 is an image of a Smartphone display illustrating a user selecting allegiance or fandom for one of the teams competing in the specific game selected, in accordance with embodiments of the present techniques;

FIG. 10 is an image of a Smartphone display illustrating a user chatting in a public chat room with users who have all selected the specific game to debate, in accordance with embodiments of the present techniques;

FIG. 11 is an image of a Smartphone display illustrating the main menu of the application of FIG. 1, in which a user has selected to set-up a private chat-room using the application of FIG. 1, in accordance with embodiments of the present techniques;

FIG. 12 is an image of a Smartphone display illustrating a user inviting other users to join the private chat room, in accordance with embodiments of the present techniques;

FIG. 13 is an image of a Smartphone display illustrating a user chatting in a private chat room with users who have all selected the specific game to debate, in accordance with embodiments of the present techniques; and

FIG. 14 is a block diagram of a system for chatting in an on-line chat room, in accordance with embodiments of the present techniques;

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill in the art and having the benefit of this disclosure.

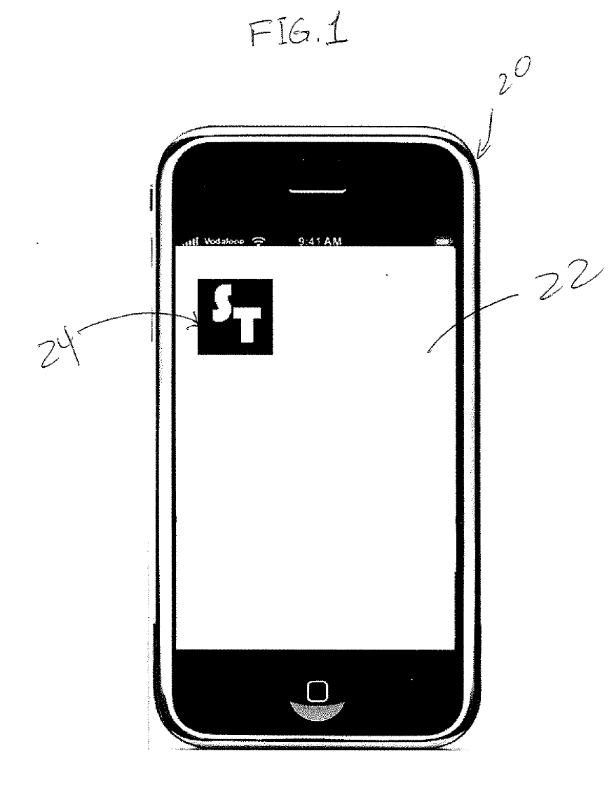

Referring generally to FIG. 1, a Smartphone 20 is presented. The Smartphone 20 is a mobile phone built on a mobile computing platform. The Smartphone 20 comprises a web browser and high-speed data access via Wi-Fi and/or mobile broadband. The Smartphone 20 comprises a mobile operating system (OS), such as Apple's iOS, Google's Android, Microsoft's Windows Phone, Nokia's Symbian, RIM's BlackBerry OS, or embedded Linux distributions such as Maemo and MeeGo. The Smartphone 20 has a display 22. The Smartphone 20 may have a keyboard or a virtual keyboard to facilitate texting. The Smartphone 20 may also have voice conversion to text capability.

The Smartphone 20 also comprises an application programming interface (API) for running third-party applications. In this embodiment, the Smartphone 20 comprises a chatting application stored in memory within the Smartphone 20 in accordance with the present invention. Operation of the chatting application is initiated by activation of an icon 24 on the display 22 of the Smartphone. 20.

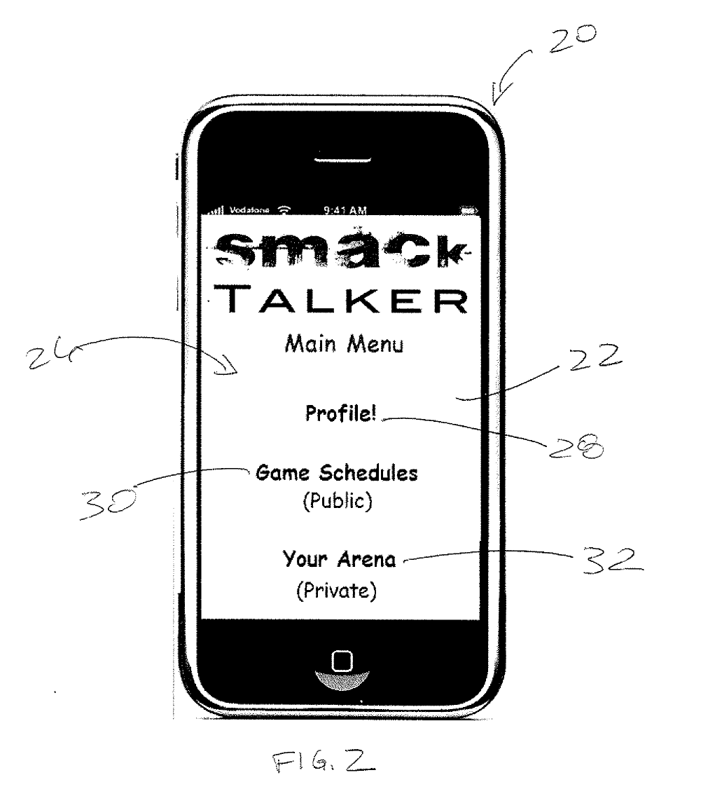

Referring generally to FIG. 2, once activated, the chatting application directs the Smartphone 20 to display an initial image 26 on the display 22. In this embodiment, the initial image is a main menu with several options available to the user. The main menu 26 comprises a link 28 to enable a user to create a user profile within the chatting application. In this embodiment, a user must crate a user profile to chat using the chatting application. In addition, the main menu 26 comprises a link 30 to schedules of upcoming events. Finally, the main menu 26 also comprises a link 32 to private chat portion of the chatting application. In this embodiment, the user has selected to create a user profile.

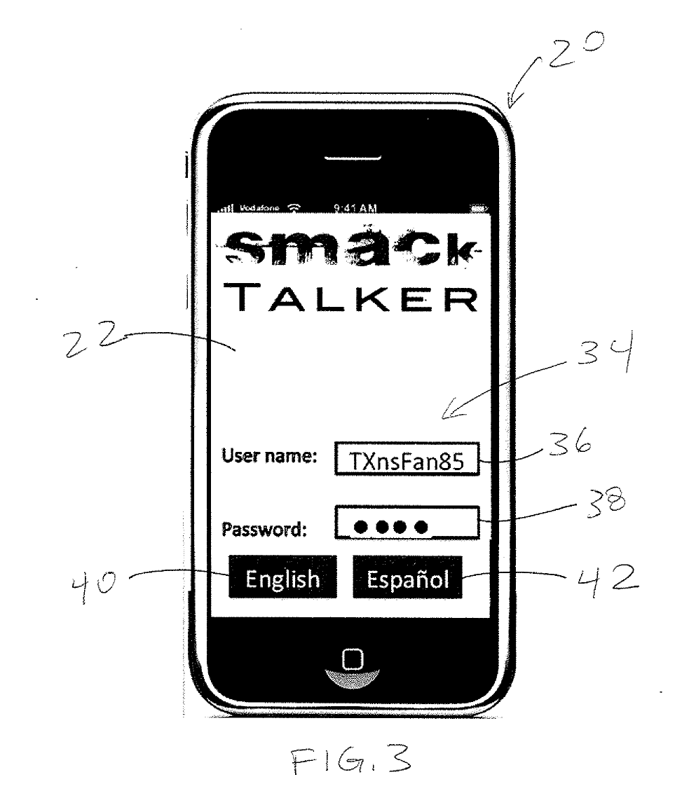

Referring generally to FIG. 3, a user has activated the link 28 to enable the user to create a personal user profile within the chatting application. In this embodiment, the chatting application directs the Smartphone 20 to produce a user profile interface 34 on the display 22. A user is asked to provide a user name in a dialog box 36 in this embodiment. In addition, the user is asked to provide a password in a dialog box 38 in this embodiment. In addition, the chatting application is adapted to communicate with users in a variety of languages. In this embodiment, the chatting application is configured to communicate with a user in either English or Spanish. A user may select to proceed in English by activating a first virtual button 40 or proceeding in Spanish by activating a second virtual button 42. However, the chatting application may be configured to communicate with users in other languages. In this embodiment, the user is directed to the next screen for creating a user profile by activating one of either the first virtual button 40 or second virtual button 42.

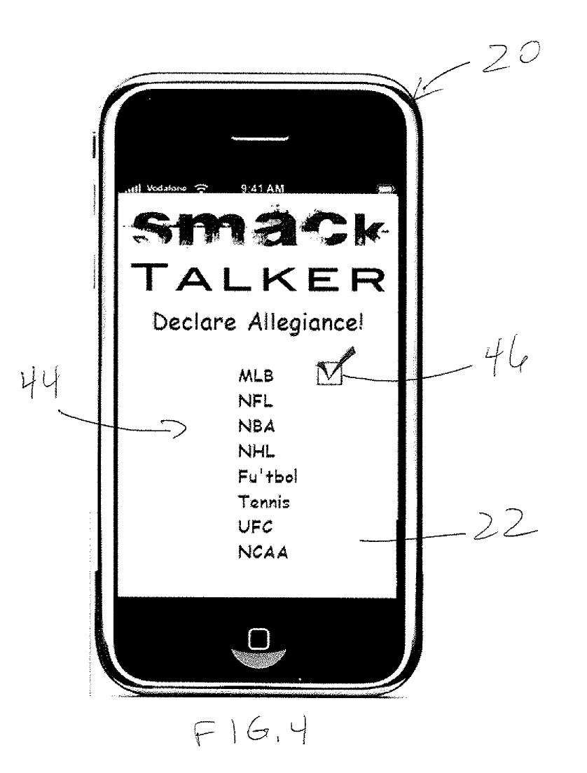

Referring generally to FIG. 4, as part of their user profile, a user may declare their allegiance to a particular team in each of a plurality of team sports or individuals in individual sports. The chatting application directs the Smartphone 20 to produce an allegiance interface 44 on the display 22 as part of the user's user profile. A user may declare allegiance to a team, such as a team in professional or college sports. In addition, a user may declare allegiance to individuals, such as a tennis player, a MMA fighter, a boxer, golfer, etc. In this embodiment, a user has selected to declare allegiance to a professional baseball team by placing a check mark in a dialog box 46 associated with professional baseball.

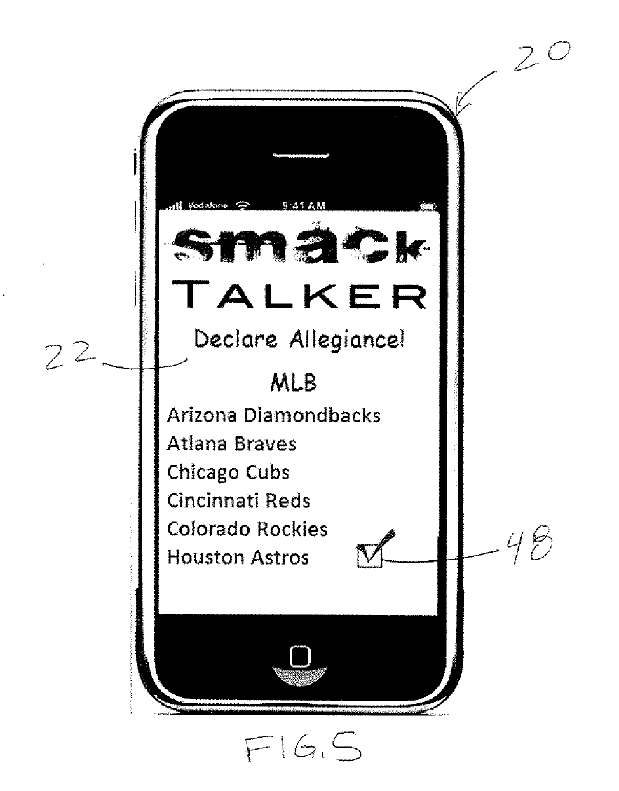

Referring generally to FIG. 5, the chatting application has directed the Smartphone to display a selection of professional baseball teams from which the user may pledge their primary allegiance. In this embodiment, the user has selected a specific baseball team by placing a check mark in a dialog box 48 next to the team's name. A user may continue to declare allegiance to teams or individuals in other sports.

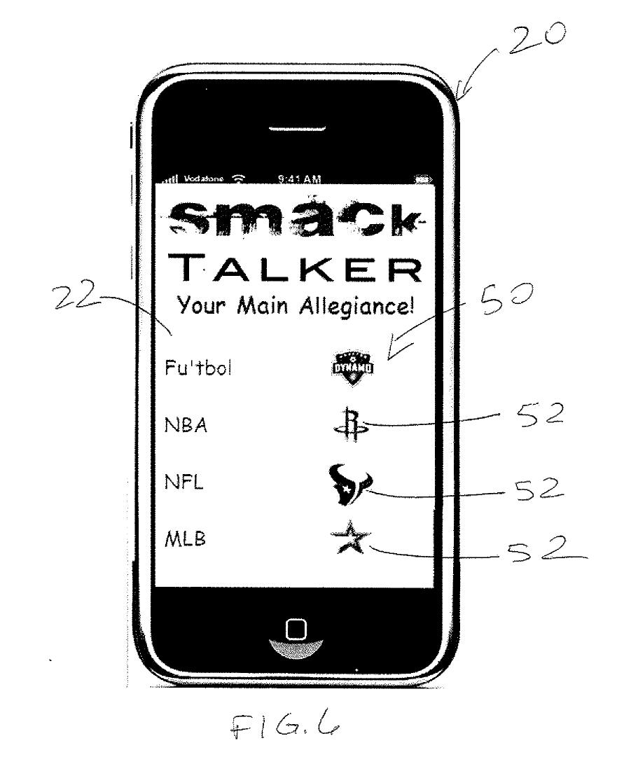

Referring generally to FIG. 6, in this embodiment, the chatting application has directed the Smartphone to display a summary 50 of the user's allegiances in the user's profile on the display 22 of the Smartphone 20. Each allegiance is represented by an icon 50 that is representative of a team or user.

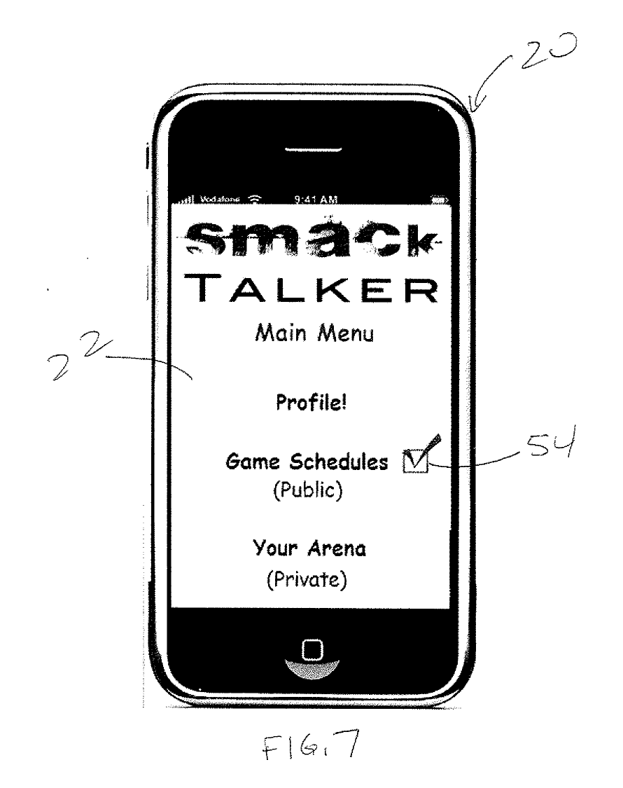

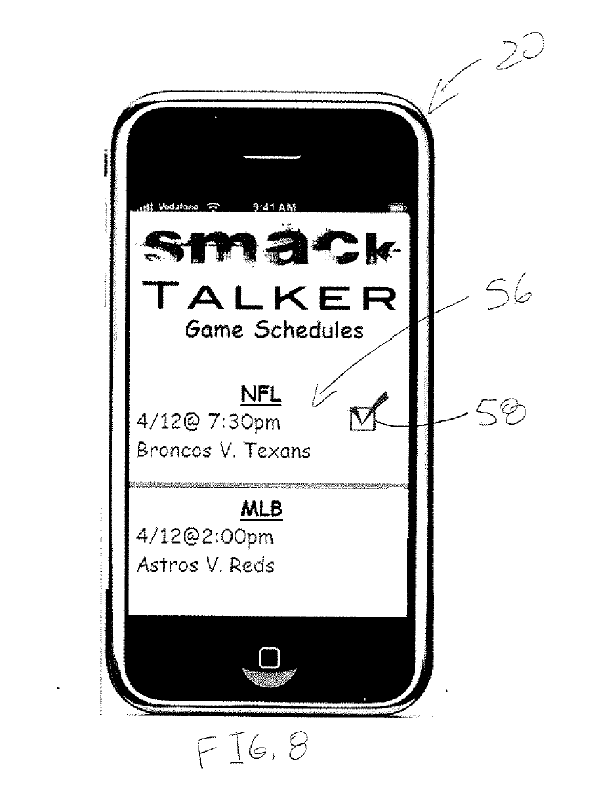

Referring generally to FIGS. 7 and 8, a link 54 is provided to enable a user to see a schedule of sporting events. By activating the link 54, a user is presented with a selection 56 of sporting events on which to chat. In this embodiment, a user checks a dialog box 58 next to a sporting event to chat about that sporting event.

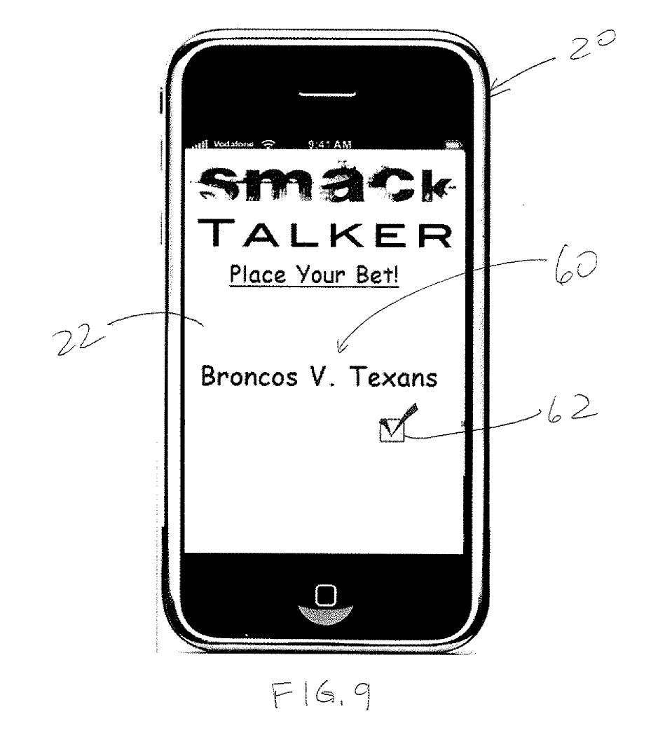

Referring generally to FIG. 9, in this embodiment, a user is presented with a display 60 of the teams, or individuals, competing in the selected sporting event and directed to select allegiance to one of the two teams, or individuals, that is competing in the selected sporting event. This information is requested even if one of the team's indicated by the user in their profile is competing. In this embodiment, the allegiance is indicated by checking a dialog box 62 next to one of the teams or individuals competing in the sporting event. The team selected may be the team indicated as the user's primary allegiance or it may not.

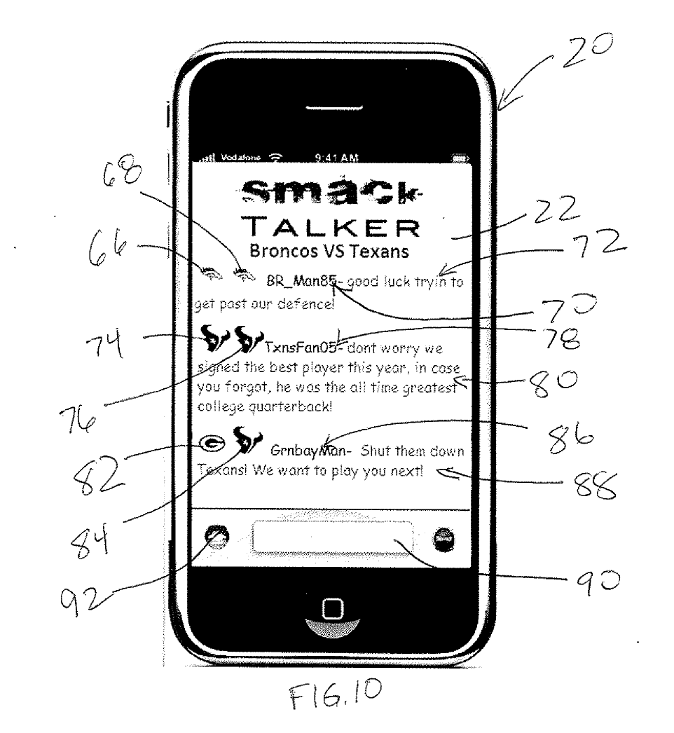

Referring generally to FIG. 10, a user is then directed to a virtual chat room for users who wish to discuss the selected sporting event. The dialog 64 in the chat room is displayed on the display 22 of the Smartphone 20. In the illustrated embodiment, a first user in the chat room has a first icon 66 that represents the first user's primary allegiance and a second icon 68 that represents the user's allegiance for the selected event. Thus, a user will know to which team the other chat room participants primary allegiance lies, as well as their alignment for the specific sporting event. In this example, the first user's primary allegiance and secondary allegiance for the event are the same. In addition, the first user's name 70 is presented on the display along with text 72 of chat provided by the first user. Similarly, a second user in the chat room has a first icon 74 that represents the second user's primary allegiance and a second icon 76 that represents the user's allegiance for the selected event. In this example, the second user's primary allegiance and secondary allegiance are the same, but differ from the first user's allegiances. The second user's name 78 is presented on the display along with text 80 of chat provided by the second user. In addition, a third user in the chat room has a first icon 82 that represents the third user's primary allegiance and a second icon 84 that represents the user's allegiance for the selected event. In this example, the third user's primary allegiance is with a team that is not competing in the selected event. However, the third user has selected a secondary allegiance to one of the competitors. In addition, the third user's name 86 is presented on the display along with text 88 of chat provided by the third user.

A user is not limited to providing text to the chat room. In the illustrated embodiment, a virtual button allows a user to use the Smartphone to upload audio to the chat room. In addition, another virtual button 92 enables a user to upload video to the chat room.

As will be discussed in more detail below, a plurality of chat rooms are created for each sporting event in this embodiment. The population of each of the plurality of chat rooms is allocated based on the user's selected allegiance for the sporting event so that relatively equal numbers of fans of each team are represented in each chat room. However, if a user's primary allegiance team is involved in the sporting event, the population of the chat room may be allocated based on the user's primary allegiance so that “provocateurs” of one team may not over-populate a chat room by claiming false allegiance to an opposing team for the selected sporting event. Alternatively, the population of each chat room may be allocated based on the a combination of both users profile allegiances and their selected allegiances for the sporting event.

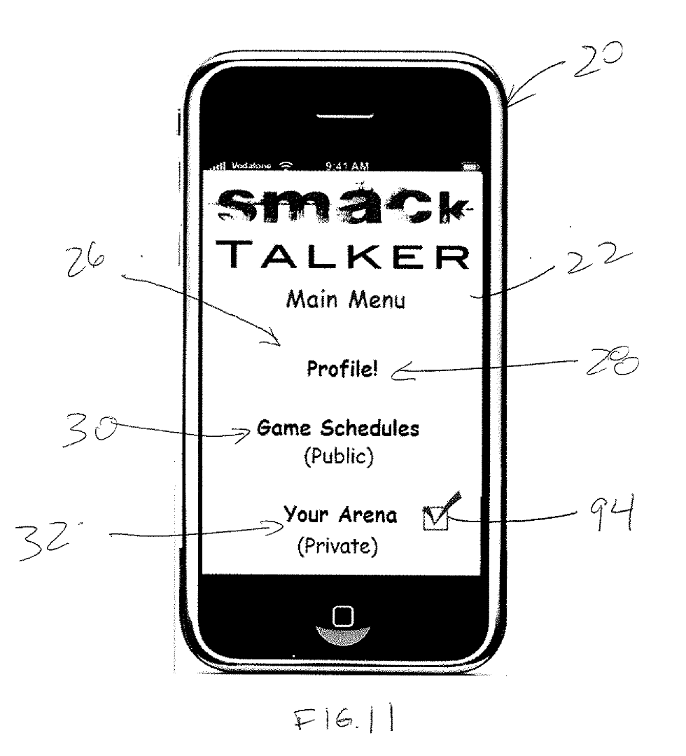

Referring generally to FIG. 11, the chatting application also enables a user to have closed chat with selected invitees. In this embodiment, a user has selected private chat by placing a check mark in a dialog box 94 next to the private chat 32 selection on the main menu 26.

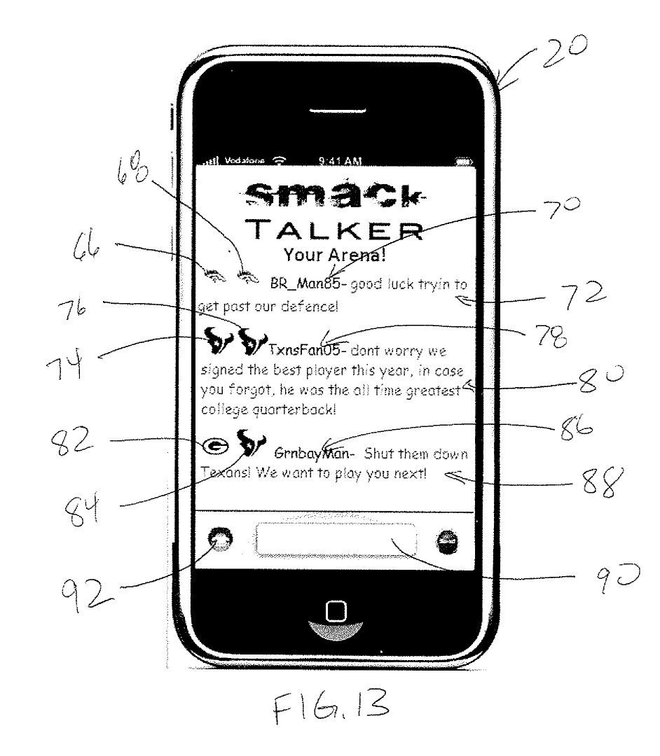

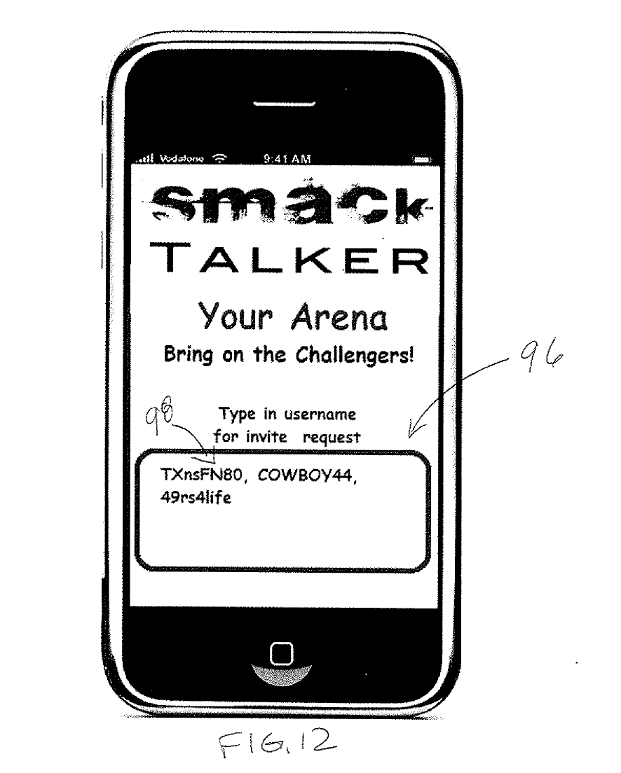

Referring generally to FIGS. 12 and 13, when private chat is activated, a user is provided with an invite display from which the user may invite specific users to chat in a private chat room based on their user name. In this embodiment, a dialog box 96 is displayed on the display 22 of the Smartphone 20. A user may then input the user names 98 of the chat room participants that the user wishes to invite to a private chat room in the dialog box 96. The user may then direct the application to send an invitation to the users to join the private chat room.

In the examples above, the chatting application was presented as an application on a Smartphone. However, the chatting application may be stored and used by any computing device with communications capability, such as desktop computers, notebook computers, and tablet computers.

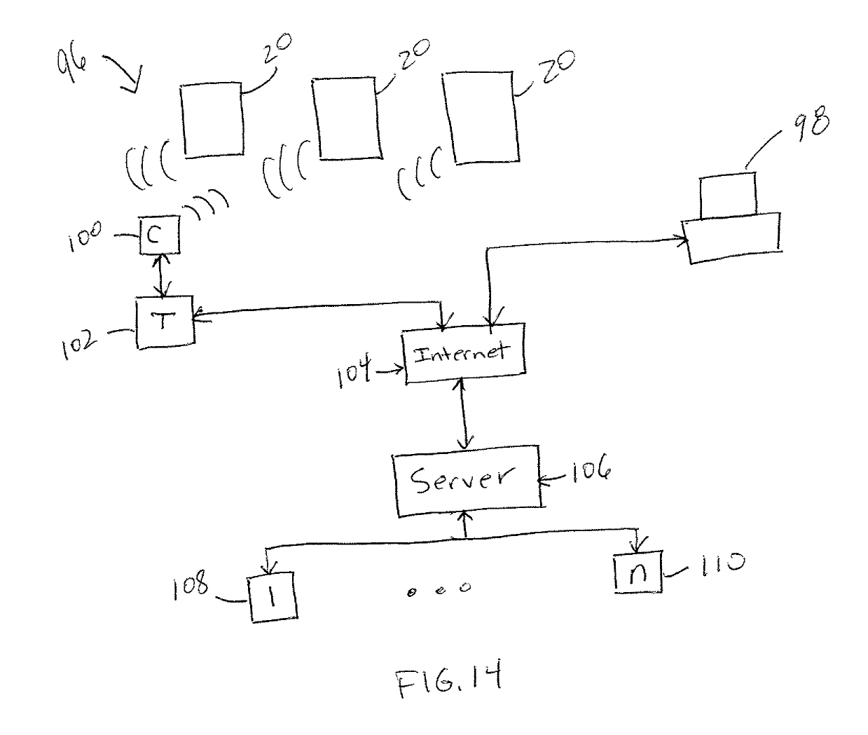

Referring generally to FIG. 14, a block diagram of an embodiment of a system for debating in an on-line chat room is presented, and represented generally by reference numeral 82. In this embodiment, users using a Smartphone 20 and a personal computer 98 are using the system to chat. The Smartphones are connected through a cell tower 100 and a telecommunications system 102 to the Internet 104. The personal computer may be connected in any number of ways to the Internet, but in this embodiment, the computer is connected to the Internet 104. The users are connected through the Internet 104 to an application server system 106 upon which the chatting application is hosted. The application server system 106 is adapted to create a plurality of virtual chat rooms 108, 110 for each sporting, entertainment, or political event. The population of each virtual chat room is based on the user's allegiance to a team or person involved in the event. In addition, the population of user's who have pled allegiance to a participant is limited in each chat room. If the number of fans of one of the participants reaches a threshold, the application server system creates an additional chat room and directs new user's to each chat room so that the population of fans of both participants is balanced between the two chat rooms.

The following is an example of how the system may operate for a given sporting event involving two participants, Team A and Team B. In this example, as users log in, the number of fans of Team A reaches the threshold amount, twenty fans, for example. Once the threshold for Team A in the first chat room is reached, new fans of Team A are directed to a second chat room as they log in. As new fans of Team B log in, the fans of Team B are distributed between the first chat room and the second chat room (and additional chat rooms if created) to try to equalize the percentage of fans of Team A and Team B in each chat room. Initially, fans of Team B may be added to the second chat room, then as the ratio of fans of Team A to Team B in the second chat rooms equals the same percentage of fans of Team A to Team B in the first chat room, fans of Team B are directed to either the first chat room or second chat room to maintain an equal percentage of fans of Team A to Team B in each chat room. Once the threshold of fans of Team A or Team B in the second chat room is reached, a third chat room is created, and so on. In addition, if a fan of Team A in the first chat room logs off, a new user logging on may be directed to the first chat room to maintain an equal percentage of fans of Team A and Team B in each chat room.

In addition to debating sports topics, the system may be configured with political chat rooms to enable debate on political topics. For example, a person may declare allegiance to a political party, politician, or a side in any given political debate. Their allegiance would be visually indicated as described above for sporting teams and individuals. Similarly, the system may be configured for any other topic in which one may debate.

What is claimed is:

1. A method of debating, comprising:
selecting a competitor to support from a selection provided by a virtual forum; and
communicating in the virtual forum, wherein a visual representation of the competitor selected by a user to support is displayed proximate to the user's communications to the virtual forum.

2. The method as recited in claim 1, wherein the virtual forum displays a selection of competitors in a specific competitive event and selecting a competitor to support from a selection provided by a virtual forum comprises selecting one of the competitors in the specific competitive event to support from the selection provided by the virtual forum.

3. The method as recited in claim 1, wherein selecting a competitor to support from a selection provided by a virtual forum comprises selecting a primary competitor within an association of competitors to support and a secondary competitor in a specific competitive event to support, wherein a visual representation of the primary competitor and the secondary competitor are displayed in the virtual forum proximate to the user's communications to the virtual forum.

4. The method as recited in claim 1, wherein the user's communications to the virtual forum comprises text.

5. The method as recited in claim 1, wherein the user's communications to the virtual forum comprises audio.

6. The method as recited in claim 1, wherein the user's communications to the virtual forum comprises video.

7. The method as recited in claim 1, comprising:
enabling a user to create a private virtual chat room and invite other users to chat in the private virtual chat room.

8. The method as recited in claim 1, comprising:
hosting the virtual forum on an Internet server and enabling a user to join the virtual forum using an electronic communication device operable to communicate via the Internet.

9. The method as recited in claim 8, wherein the electronic communication device is a Smartphone.

10. A method of chatting in a virtual forum, comprising:
presenting a selection of competitors to a virtual forum participant connected to the virtual forum;
requiring each virtual forum participant to select one competitor from the selection of competitors to support;
creating a first virtual chat room to enable a virtual forum participant to communicate with another virtual forum participant;
creating a second virtual chat room to enable new virtual forum participants to communicate with other new virtual forum participants when a threshold number of virtual forum participants in the first chat room is reached; and
directing a new virtual forum participant to one of the first or second virtual chat room based on their selection of competitor to support.

11. The method as recited in claim 10, wherein directing a new virtual forum participant to one of the first or second virtual chat room based on their selection of competitor to support comprises directing a new virtual forum participant to a virtual chat room to equalize ratios of supporters of one competitor to another competitor in each chat room.

12. The method as recited in claim 10, wherein the threshold number of users in the first virtual chat room is a threshold number of virtual forum participants in the first virtual chat room who have selected one competitor to support.

13. The method as recited in claim 10, wherein the threshold number of virtual forum participants in the first virtual chat room is a total number of virtual forum participants in the first virtual chat room.

14. The method as recited in claim 10, wherein a visual representation of the competitor selected by a virtual forum participant user to support is displayed in the virtual forum proximate to each virtual forum participant's communications to the first or second virtual chat room.

15. The method as recited in claim 10, wherein the virtual forum enables a virtual forum participant to communicate text to other virtual forum participants.

16. The method as recited in claim 10, wherein the virtual forum enables a virtual forum participant to communicate audio to other virtual forum participants.

17. The method as recited in claim 10, wherein the virtual forum enables a virtual forum participant to communicate video to other virtual forum participants.

18. A system for chatting, comprising:
a virtual forum; and
a software program storable within a memory of an electronic device, wherein the software program enables the electronic device to communicate with the virtual forum;
wherein a user is required to select a competitor from a selection of competitors presented by the system and a visual representation of the competitor selected by the user is displayed on the electronic device proximate to the user's communications to the virtual forum.

19. The system as recited in claim 18, wherein the electronic device is a Smartphone.

20. The system as recited in claim 18, wherein the selection of competitors is a selection of competitors in a specific competitive event.

21. The system as recited in claim 18, wherein the selection of competitors is a selection of competitors in an association of competitors.
